(19) United States
(12) Patent Application Publication
(10) Pub. No.: US 2025/0074161 A1
(43) Pub. Date: Mar. 6, 2025

(54) VEHICULAR AIR CONDITIONING SYSTEM

(71) Applicant: Hanon Systems, Daejeon (KR)

(72) Inventors: Dong Hoon OH, Daejeon (KR); Young Min KIM, Daejeon (KR); Dae Bok KEON, Daejeon (KR)

(21) Appl. No.: 18/725,162

(22) PCT Filed: Apr. 11, 2023
(86) PCT No.: PCT/KR2023/004838

§ 371 Date: Jun. 28, 2024

(30) Foreign Application Priority Data
Apr. 12, 2022 (KR) 10-2022-0044924

(51) Int. Cl. B60H 1/34

(52) U.S. Cl. CPC B60H 1/34

(57) ABSTRACT

A vehicular air conditioning system having an air inlet and an air outlet includes a first heating heat exchanger configured to heat air introduced through the air inlet, a second heating heat exchanger configured to heat air passing through the first heating heat exchanger or bypassing the first heating heat exchanger, and a control part configured to control the first heating heat exchanger and the second heating heat exchanger according to a passenger room heating load so that when the heating load decreases to below a preset value in a heating mode in which the first heating heat exchanger and the second heating heat exchanger are operated simultaneously, the first heating heat exchanger is first turned off and only the second heating heat exchanger is operated.

### TECHNICAL FIELD

The present invention relates to a vehicular air conditioning system, and more particularly, a vehicular air conditioning system capable of, in a heating mode, effectively and quickly heating a floor area of a passenger room while minimizing energy consumption, and improving comfort in the passenger room by making different the temperature of discharged air in an upper space and a lower space of the passenger room.

### BACKGROUND ART

A vehicle is provided with an air conditioning system for cooling and heating a passenger room. As shown in FIG. 1, such an air conditioning system includes an air conditioning case 1. A cooling heat exchanger 3 and a heating heat exchanger 5 are installed in an internal flow path 1a of the air conditioning case 1.

The cooling heat exchanger 3 cools the air introduced into an air inlet (not shown) and the air is blown into the passenger room along the internal flow path 1a of the air conditioning case 1.

The heating heat exchanger 5 heats the air introduced into the air inlet and the air is blown into the passenger room along the internal flow path 1a of the air conditioning case 1.

In particular, the heating heat exchanger 5 includes a heater core using engine cooling water or an indoor heat exchanger using a refrigerant of a heat pump (hereinafter, the heater core or the indoor heat exchanger will be designated by reference numeral “5a”). The heating heat exchanger 5 heats the air blown into the passenger room by releasing the heat of the high-temperature engine cooling water or the heat of the refrigerant.

Meanwhile, the heating heat exchanger 5 further includes a PTC heater 5b installed on the downstream side of the heater core or the indoor heat exchanger 5a.

The PTC heater 5b generates heat using the electricity applied thereto. When the heat generation amount of the heater core or the indoor heat exchanger 5a is insufficient, the PTC heater 5b serves to heat the air blown into the passenger room in cooperation with the heater core or the indoor heat exchanger 5a, or instead of the heater core or the indoor heat exchanger 5a.

The air conditioning case 1 is provided with a plurality of air discharge ports for discharging the air from the internal flow path 1a into the passenger room.

Examples of the air discharge ports include a defrost vent 7, a face vent 8, a floor vent 9, and a rear floor vent 10.

The defrost vent 7 discharges the air from the internal flow path 1a to the window glass side in the passenger room, and the face vent 8 discharges the air from the internal flow path 1a to the passenger's face.

The floor vent 9 extends to the floor on the front seat side in the passenger room through floor ducts 9a. The floor vent 9 discharges the air in the internal flow path 1a to the floor on the front seat side in the passenger room.

The rear floor vent 10 extends to the rear seat area in the passenger room through rear ducts 10a. The rear floor vent 10 extended in this way discharges the air in the internal flow path 1a to the floor on the rear seat side in the passenger room.

However, such a conventional air conditioning system has a disadvantage in that in a heating mode, the heating performance in the passenger room is poor and the energy consumption is high.

That is, in the heating mode, the PTC heater 5b is also used since the heat generation amount of the heater core and the indoor heat exchanger 5a is insufficient. In this case, there is a disadvantage that energy consumption increases rapidly.

In particular, the PTC heater 5b has a disadvantage in that it consumes a lot of electricity. This leads to a problem that the fuel efficiency of the vehicle is reduced.

Additionally, vents having a long air discharge path, for example, a floor vent 9 having a long air discharge path to a floor portion on the front seat side, and a rear floor vent 10 having a long air discharge path to a floor portion on the rear seat side, suffer from a disadvantage in that a lot of heat loss occurs when the air heated by the heating heat exchanger 5 is fed to the floor portions on the front seat side and the rear seat side.

This leads to a problem in that the heating performance for the floor portions on the front and rear seat sides is significantly reduced. As a result, the comfort in the passenger room is deteriorated.

In particular, at the beginning of heating, the temperature in the passenger room is very low, and therefore, the heat loss generated during the process of air flow to the floor portions on the front and rear seat sides is very large. Thus, at the beginning of heating, the rapid heating efficiency is significantly reduced.

In view of this, the heat loss generated during the air flow process may be compensated by increasing the heat generation amount in the PTC heater 5b. However, in this case, electricity consumption sharply increases, drastically reducing the fuel efficiency of the vehicle.

In addition, the conventional air conditioning system is configured so that the cold air passed through the cooling heat exchanger 3 and the hot air passed through the heating heat exchanger 5 are mixed and discharged into the passenger room. Therefore, the air temperatures are substantially equal in different areas in the passenger room. This leads to a problem in that the discharged air temperature cannot be made different in respective areas in the passenger room.

In particular, passengers in the passenger room feel comfortable only in a cold-head and hot-leg state in which air having a relatively low temperature is discharged to an upper space in the passenger room corresponding to the passenger's head and air having a relatively high temperature is discharged to a lower space in the passenger room corresponding to the passenger's torso or legs.

However, if the discharged air temperature in the passenger room is substantially equal in different areas of the passenger room as in the prior art, the discharged air temperature cannot be made different in the upper and lower spaces of the passenger room, which may significantly reduce the comfort in the passenger room.

### SUMMARY

In view of the problems inherent in the related art, it is an object of the present invention to provide a vehicular air conditioning system capable of effectively heating a passenger room in a heating mode while minimizing energy consumption.

Another object of the present invention is to provide a vehicular air conditioning system capable of improving the fuel efficiency without reducing the comfort in a passenger room, by adopting a configuration in which the passenger room can be effectively heated while minimizing energy consumption.

A further object of the present invention is to provide a vehicular air conditioning system capable of preventing an increase in heat generation amount of a PTC electric heater for compensating a heat loss of air on the side of a long air discharge path and effectively heating an area in a passenger room corresponding to the long air discharge path while minimizing energy consumption, by adopting a configuration in which the air on the vent side fed along the long air discharge path can be heated efficiently with minimal energy.

A still further object of the present invention is to provide a vehicular air conditioning system capable of improving the rapid heating efficiency for an area in a passenger room corresponding to a long air discharge path at the beginning of heating, by adopting a configuration in which the air on the side of a long air discharge path can be rapidly heated with minimal energy.

A yet still further object of the present invention is to provide a vehicular air conditioning system capable of making different a discharged air temperature in upper and lower spaces of a passenger room, by adopting a configuration in which the air discharged to the lower space of the passenger room can be heated independently.

An even yet still further object of the present invention is to provide a vehicular air conditioning system capable of maintaining a cold-head and hot-leg state in which air having a low temperature is discharged to an upper space of a passenger room and air having a high temperature is discharged to a lower space of the passenger room, and consequently improving the comfort in the passenger room, by adopting a configuration in which a discharged air temperature can be made different in upper and lower spaces of the passenger room.

According to one embodiment of the present invention, there is provided a vehicular air conditioning system having an air inlet and an air outlet, including: a first heating heat exchanger configured to heat an air introduced through the air inlet; a second heating heat exchanger configured to heat an air passing through the first heating heat exchanger or bypassing the first heating heat exchanger; and a control part configured to control the first heating heat exchanger and the second heating heat exchanger according to a passenger room heating load so that when the heating load decreases to below a preset value in a heating mode in which the first heating heat exchanger and the second heating heat exchanger are operated simultaneously, the first heating heat exchanger is first turned off and only the second heating heat exchanger is operated.

The first heating heat exchanger includes a plurality of first heating heat exchangers.

The first heating heat exchanger includes at least one of a heater core using engine cooling water, an indoor heat exchanger using a refrigerant of a heat pump, and a PTC heater using electricity.

The first heating heat exchanger includes the indoor heat exchanger and the PTC heater, and the control part is configured to, when an outside air temperature is equal to or lower than a preset reference temperature, turn off the indoor heat exchanger of the first heating heat exchanger, turn on the PTC heater, turn on the second heating heat exchanger, and turn on a blower so that the PTC heater of the first heating heat exchanger and the second heating heat exchanger are operated to heat a passenger room.

The control part is configured to, when the passenger room heating load is equal to or larger than a pre-stored first reference heating load, turn on the indoor heat exchanger and the PTC heater of the first heating heat exchanger, the second heating heat exchanger, and the blower, so that under the condition that the passenger room heating load is equal to or larger than the first reference heating load, the indoor heat exchanger and the PTC heater of the first heating heat exchanger and the second heating heat exchanger are all operated to heat the passenger room.

The control part is configured to, when the passenger room heating load is smaller than the first reference heating load and equal to or larger than a second reference heating load smaller than the first reference heating load, turn on the indoor heat exchanger of the first heating heat exchanger, turn off the PTC heater, turn on the second heating heat exchanger, and turn on the blower, so that under the condition that the passenger room heating load is smaller than the first reference heating load and equal to or larger than the second reference heating load, the indoor heat exchanger of the first heating heat exchanger and the second heating heat exchanger are operated to heat the passenger room.

The control part is configured to, when the passenger room heating load is smaller than the second reference heating load and equal to or larger than a third reference heating load smaller than the second reference heating load, turn off the indoor heat exchanger and the PTC heater of the first heating heat exchanger, turn on a planar heating element of the second heating heat exchanger, and turn on the blower, so that under the condition that the passenger room heating load is smaller than the second reference heating load and equal to or larger than the third reference heating load, only the second heating heat exchanger is operated to heat the passenger room with the heat thereof.

The control part is configured to, when the passenger room heating load is smaller than the third reference heating load, turn off the indoor heat exchanger and the PTC heater of the first heating heat exchanger, turn off the blower, and turn on only the second heating heat exchanger, so that under the condition that the passenger room heating load is smaller than the third reference heating load, only the second heating heat exchanger is operated to radiatively heat the passenger room with the radiant heat thereof.

According to another embodiment of the present invention, there is provided a vehicular air conditioning system having an air inlet and an air outlet, including: a first heating heat exchanger configured to heat air introduced through the air inlet; a second heating heat exchanger configured to heat air passing through the first heating heat exchanger or bypassing the first heating heat exchanger; and a control part configured to control the first heating heat exchanger and the second heating heat exchanger according to a passenger room heating load so that the second heating heat exchanger is turned on in a heating mode.

The second heating heat exchanger is installed at an air discharge port of a vent that discharges air toward a floor of a passenger room among a plurality of vents for discharging air into the passenger room.

The second heating heat exchanger includes a second heating heat exchanger installed at an air discharge port of a front seat side floor vent that discharges air to a floor in a front seat area of the passenger room, and a second heating heat exchanger installed at an air discharge port of a rear seat side floor vent that discharges air to a floor in a rear seat area of the passenger room.

According to the vehicular air conditioning system of the present invention, the second heating heat exchanger, which is a planar heating element, is installed at the end of the air discharge path of the floor vent and the rear floor vent to directly heat the air discharged to the floor in the front and rear seat areas of the passenger room. Therefore, in the heating mode, it is possible to efficiently heat the air on the floor vent and rear floor vent sides that are fed along the long air discharge path.

In addition, since the air on the floor vent and rear floor vent side can be heated efficiently, it is possible to quickly and effectively heat the floor side spaces in the front and rear seat areas of the passenger room that are relatively distant from the air conditioning case. As a result, the comfort in the passenger room can be improved by improving the rapid cooling efficiency for the floor side spaces in the front and rear seat areas of the passenger room at the beginning of heating.

In addition, since the air discharged to the floor side spaces in the front and rear seat areas of the passenger room is heated by the low-power high-efficiency planar heating element, it is possible to heat the air fed to the floor side spaces in the front and rear seat areas of the passenger room along the air discharge path to a high temperature while consuming less energy.

In addition, since the air fed to the floor side spaces in the front and rear seat areas of the passenger room along the air discharge path can be heated to a high temperature while consuming less energy, unlike the prior art, it is not necessary to increase the heat generation amount in the PTC heater to compensate for the heat loss of the air in the process of feeding the air to the floor side spaces in the front and rear seat areas of the passenger room.

As a result, it is possible to heat the front and rear seat areas of the passenger room more efficiently while minimizing energy consumption, thereby improving both the comfort in the passenger room and the fuel efficiency of the vehicle.

In addition, since the temperature of the air discharged to the lower space of the passenger room can be independently controlled by the second heating heat exchangers on the floor vent and rear floor vent sides, it is possible to make different the temperature of the air discharged to the lower space of the passenger room and the temperature of the air discharged to the upper space of the passenger room.

In addition, since the temperature of the air discharged to the lower space of the passenger room and the temperature of the air discharged to the upper space of the passenger room can be made different, it is possible to make the air discharged to the lower space of the passenger room higher than the temperature of the air discharged to the upper space of the passenger room.

As a result, it is possible to maintain a cold-head and hot-leg state and improve the comfort in the passenger room.

### BRIEF DESCRIPTION OF THE DRAWINGS

FIG. 1 is a view showing a conventional vehicular air conditioning system.

FIG. 2 is a view showing the configuration of a vehicular air conditioning system according to the present invention.

FIG. 3 is a plan view showing the vehicular air conditioning system according to the present invention installed in a vehicle.

FIGS. 4 and 5 are flow charts showing an operation example of the vehicular air conditioning system according to the present invention.

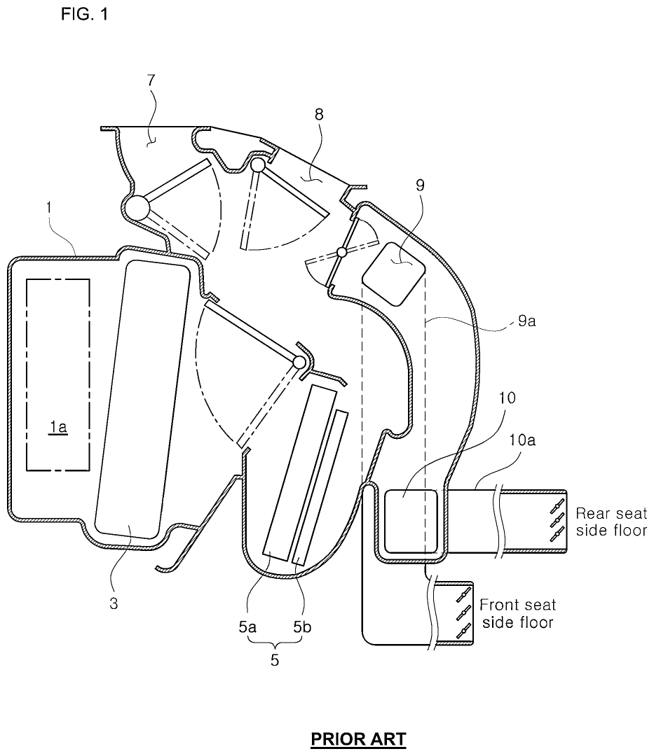

### DETAILED DESCRIPTION

A preferred embodiment of a vehicular air conditioning system according to the present invention will now be described in detail with reference to the accompanying drawings (The same components as those of the prior art are designated by like reference numerals).

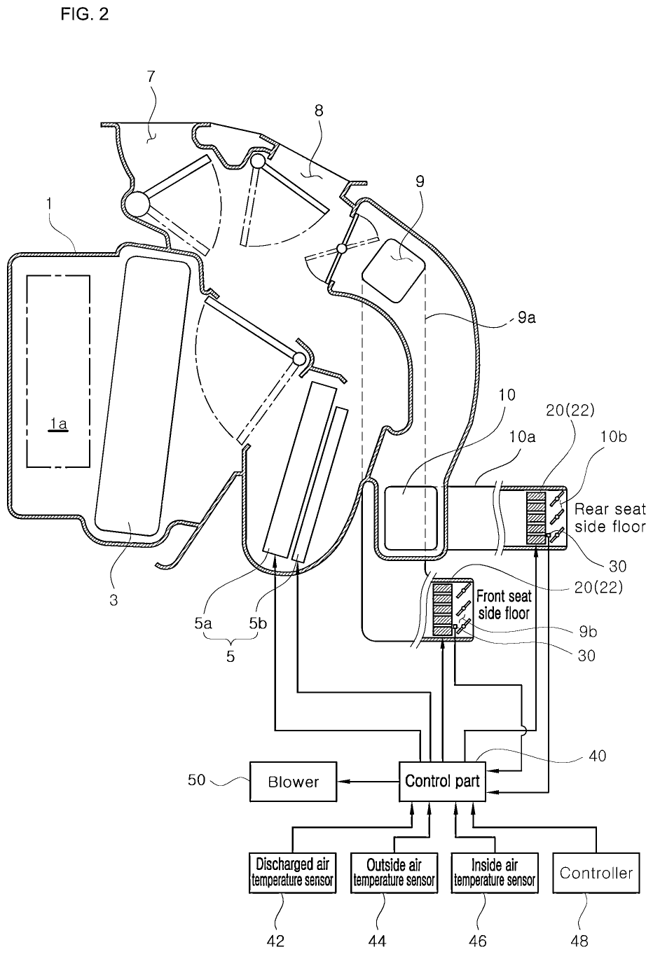

Prior to describing the features of the vehicular air conditioning system according to the present invention, the vehicle air conditioning system will be briefly described with reference to FIG. 2.

The vehicular air conditioning system includes an air conditioning case 1. A cooling heat exchanger 3 and heating heat exchangers 5 are installed on the air conditioning case 1.

The cooling heat exchanger 3 cools the air blown into the passenger room along the internal flow path 1a of the air conditioning case 1. The heating heat exchangers 5 heat the air blown into the passenger room along the internal flow path 1a of the air conditioning case 1.

In this regard, the heating heat exchangers 5 include a heater core using engine cooling water or an indoor heat exchanger 5a using a refrigerant of a heat pump. The heating heat exchangers 5 heat the air blown into the passenger room by releasing the heat of the high-temperature engine cooling water or the heat of the refrigerant.

The heating heat exchangers 5 further include a PTC heater 5b installed on the downstream side of the heater core or the indoor heat exchanger 5a.

When the heat generation amount of the heater core or the indoor heat exchanger 5a is insufficient, the PTC heater 5b serves to heat the air blown into the passenger room in cooperation with the heater core or the indoor heat exchanger 5a, or instead of the heater core or the indoor heat exchanger 5a.

The air conditioning case 1 is provided with a plurality of air discharge ports for discharging the air from the internal flow path 1a into the passenger room.

Examples of the air discharge ports include a defrost vent 7, a face vent 8, a floor vent 9, and a rear floor vent 10.

The defrost vent 7 discharges the air from the internal flow path 1a to the window glass side in the passenger room, and the face vent 8 discharges the air from the internal flow path 1a to the passenger's face.

The floor vent 9 extends to the floor on the front seat side in the passenger room through floor ducts 9a. The floor vent 9 discharges the air in the internal flow path 1a to the floor on the front seat side in the passenger room.

The rear floor vent 10 extends to the rear seat area in the passenger room through rear ducts 10a. The rear floor vent 10 extended in this way discharges the air in the internal flow path 1a to the floor on the rear seat side in the passenger room.

Next, the features of the vehicular air conditioning system according to the present invention will be described in detail with reference to FIGS. 2 to 4.

Referring first to FIG. 2, the air conditioning system of the present invention includes second heating heat exchangers 20 respectively installed at the vents of the air conditioning case 1 that discharge air toward the floor in the passenger room, for example, the floor vent 9 and the rear floor vent 10. Hereinafter, the second heating heat exchangers 20 will be referred to as “second heating heat exchangers 20”, and the heating heat exchangers 5 will be referred to as “first heating heat exchangers 5”.

The second heating heat exchangers 20 are composed of porous planar heating elements 22 capable of performing radiant heating, and are installed at the ends of the air discharge paths of the floor vent 9 and the rear floor vent 10, i.e., the air discharge ports 9b and 10b, respectively.

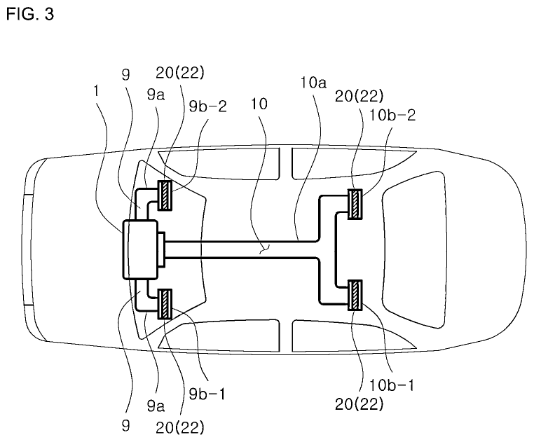

In particular, as shown in FIG. 3, the second heating heat exchangers 20 are installed in the floor vent 9 at an air discharge port 9b-1 of a driver seat side floor duct 9a extending to a driver seat area and an air discharge port 9b-2 of a passenger seat side floor duct 9a extending to a passenger seat area.

In addition, the second heating heat exchangers 20 are installed in the rear floor vent 10 at an air discharge port 10b-1 of a rear seat left rear duct 9a extending to a rear seat left area and an air discharge port 10b-2 of a rear seat right rear duct 10a extending to a rear seat right area.

Since the second heating heat exchangers 20 are installed on the floor vent 9 and the rear floor vent 10, they can directly heat the air discharged to the floor in the front seat area and the rear seat area of the passenger room.

In particular, since the second heating heat exchangers 20 are installed at the ends of the air discharge paths of the floor vent 9 and the rear floor vent 10, they can heat the air just before being discharged to the floor in the front seat area and the rear seat area of the passenger room.

Accordingly, it is possible to efficiently heat the air on the floor vent 9 side and the rear floor vent 10 side, which is fed along the long air discharge paths.

As a result, it is possible to quickly and effectively heat the floor side spaces in the front seat area and the rear seat area of the passenger room that are relatively distant from the air conditioning case 1.

As a result, it is possible to improve the rapid heating efficiency for the floor side spaces in the front seat area and the rear seat area of the passenger room, thereby improving the comfort in the passenger room.

In addition, since the second heating heat exchangers 20 heat the air just before being discharged to the floor in the front seat area and the rear seat area of the passenger room, the air fed along the long air discharge paths to the floor in the front seat area and the rear seat area of the passenger room can be heated to a high temperature.

In particular, since the second heating heat exchangers 20, which are planar heating elements 22, are capable of generating heat with low power and high efficiency, the air fed along the long discharge path to the floor in the front seat area and the rear seat area of the passenger room can be heated to a high temperature while consuming less energy.

Therefore, unlike the prior art, it is not necessary to increase the heat generation amount in the PTC heater 5b to compensate for the heat loss of the air in the process of feeding the air to the floor in the front seat area and the rear seat area of the passenger room.

Thus, the front and rear seat areas of the passenger room can be heated more efficiently while minimizing energy consumption. As a result, it is possible to improve both the comfort in the passenger room and the fuel efficiency of the vehicle.

In addition, since the second heating heat exchangers 20 are installed on the floor vent 9 side and the rear floor vent 10 side, it is possible to independently control the temperature of the air discharged to the lower spaces in the front and rear seat areas of the passenger room.

Accordingly, it is possible to make different the temperature of the air discharged to the lower space in the passenger room and the temperature of the air discharged to the upper space in the passenger room.

In particular, the temperature of the air discharged to the lower space in the passenger room can be made higher than the temperature of the air discharged to the upper space in the passenger room. As a result, it is possible to maintain a cold-head and hot-leg state for the passengers, thereby improving the comfort in the passenger room.

Meanwhile, since the second heating heat exchangers 20 are installed on the floor vent 9 side and the rear floor vent 10 side, it is possible to selectively heat the air which has passed through the first heating heat exchangers 5 or which has bypassed the first heating heat exchangers 5.

In addition, since the first heating heat exchangers 5 can heat the air discharged into the passenger room in cooperation with the second heating heat exchangers 20 or can heat the air regardless of the second heating heat exchangers 20.

Referring again to FIG. 2, the air conditioning system of the present invention further includes second heating heat exchanger temperature sensors 30 that detect the temperatures of the second heating heat exchangers 20.

The second heating heat exchanger temperature sensors 30 are installed on the downstream surface portions of the second heating heat exchangers 20. The second heating heat exchanger temperature sensors 30 installed in this way serve to detect the temperatures of the second heating heat exchangers 20.

In particular, the second heating heat exchanger temperature sensors 30 detect the temperatures of the second heating heat exchangers 20 installed on the air discharge port 9b of the floor vent 9 and the air discharge port 10b of the rear floor vent 10, and inputs the detected temperature data to a control part 40 described later.

The air conditioning system of the present invention further includes a control part 40.

The control part 40 includes a microprocessor and controls the first and second heating heat exchangers 5 and 20 according to the heating load in the passenger room.

In particular, the control part 40 controls the on/off operations of the first and second heating heat exchangers 5 and 20 according to the heating load in the passenger room.

For example, as shown in Table 1 below, when the outside air temperature, which is a factor of the heating load in the passenger room, is equal to or lower than a preset reference temperature, the indoor heat exchanger 5a of the first heating heat exchangers 5 is turned off (the compressor of the heat pump type air conditioning system is turned off), the PTC heater 5b of the first heating heat exchangers 5 is turned on, and the planar heating elements 22 of the second heating heat exchangers 20 are turned on. At this time, the control part 40 turns on the blower 50.

Therefore, when the outside air temperature is equal to or lower than the reference temperature, only the PTC heater 5b of the first heating heat exchangers 5 and the planar heating elements 22 of the second heating heat exchangers 20 are operated to heat the passenger room.

In this regard, the reference temperature stored in the control part 40 is set to a specific sub-zero temperature. Preferably, the reference temperature is set to −20 degrees C., which is a specific sub-zero temperature at which the heat pump type air conditioning system cannot operate.

The reason for setting the reference temperature to a specific sub-zero temperature (−20 degrees C. and turning off the indoor heat exchanger 5a under the passenger room heating load condition where the outside air temperature is equal to or lower than the specific sub-zero temperature (−20 degrees C.) is that as described above, the heat pump type air conditioning system cannot operate when the outside air temperature is equal to or lower than −20 degrees C.

TABLE 1

| | | Heating load | | | | |
|---|---|---|---|---|---|---|
| | | Large <-----------------------------------------> Small | | | | |
| | | | Heat pump operable | | | |
| | | | | First | | |
| | | | | reference | | |
| | | | | heating | | |
| | | | | load | Second | |
| | | | | > | reference | |
| | | | Passenger | Passenger | heating load | |
| | | | room | room | > | Third reference |
| | | Heat pump | heating | heating | Passenger | heating |
| | | inoperable | load | load | room | load |
| | | Outside air | ≥ | ≥ | heating load | > |
| | | temperature | First | Second | ≥ | Passenger |
| | | ≤ | reference | reference | Third | room |
| Heating heat | | Reference | heating | heating | reference | heating |
| exchanger | | temperature | load | load | heating load | load |
| First | Indoor heat | x | ∘ | ∘ | x | x |
| heating | exchanger | | | | | |
| heat | (heat pump) | | | | | |
| ex- | PTC heater | ∘ | ∘ | x | x | x |
| changer | | | | | | |
| Second | Planar heating | ∘ | ∘ | ∘ | ∘ | ∘ |
| heating | element | | | | | |
| heat | | | | | | |
| ex- | | | | | | |
| changer | | | | | | |

| | | | | | |
|---|---|---|---|---|---|
| Blower | ∘ | ∘ | ∘ | ∘ | x |

Meanwhile, the control part 40 is configured to calculate a passenger room heating load using factors such as the temperature of the air discharged into the passenger room, the outside air temperature, the inside air temperature, the user set temperature, the target discharge temperature, and the like under the condition that the heat pump type air conditioning system is operable, for example, under the condition that the outside air temperature exceeds −20 degrees C., and control the on/off operations of the first heating heat exchangers 5 and the second heating heat exchangers 20 according to the passenger room heating load thus calculated.

In more detail, the control part 40 acquires information on factors affecting the passenger room heating load using the detection values inputted from the discharged air temperature sensors 42 installed on the air discharge port side of the respective vents 7, 8, 9 and 10, the outside air temperature sensor 44 and the inside air temperature sensor 46, and the user-set temperature inputted from the controller 48.

For example, the control part 40 acquires the temperature of the air discharged into the passenger room, the outside air temperature, the inside air temperature, the user set temperature, and the target discharge temperature.

Then, the control part 40 calculates the passenger room heating load by processing at least one of the temperature of the air discharged into the passenger room, the outside air temperature, the inside air temperature, the user set temperature, and the target discharge temperature using a preset logic, and controls the on/off operations of the first heating heat exchangers 5 and the second heating heat exchangers 20 according to the magnitude of the heating load thus calculated.

In particular, the control part 40 compares the calculated heating load with the magnitude of a pre-stored reference heating load, and controls the on/off operations of the first heating heat exchangers 5 and the second heating heat exchangers 20 according to the results of comparison.

For example, under the condition that the calculated passenger room heating load is equal to or larger than the pre-stored first reference heating load as shown in Table 1 above, the control part 40 turns on the indoor heat exchanger 5a of the first heating heat exchangers 5 (turns on the compressor of the heat pump type air conditioning system), turns on the PTC heater 5b, and turns on the planar heating elements 22 of the second heating heat exchangers 20 and the blower 50.

Therefore, under the condition that the passenger room heating load is equal to or larger than the first reference heating load, the indoor heat exchanger 5a and the PTC heater 5b of the first heating heat exchangers 5 and the planar heating elements 22 of the second heating heat exchangers 20 are all operated to heat the passenger room.

In addition, under the condition that the calculated passenger room heating load is smaller than the first reference heating load and equal to or larger than a second reference heating load smaller than the first reference heating load as shown in Table 1 above, the control part 40 turns on the indoor heat exchanger 5a of the first heating heat exchangers 5, turns off the PTC heater 5b, and turns on the planar heating elements 22 of the second heating heat exchangers 20 and the blower 50.

Therefore, under the condition that the passenger room heating load is smaller than the first reference heating load and equal to or larger than the second reference heating load, only the indoor heat exchanger 5a of the first heating heat exchangers 5 and the planar heating elements 22 of the second heating heat exchangers 20 are operated to heat the passenger room.

Thus, it is possible to suppress the operation of the PTC heater 5b, which consumes a lot of power, thereby minimizing energy consumption in the heating mode and effectively heating the passenger room.

As a result, it is possible to improve the fuel efficiency of the vehicle without deteriorating the comfort in the passenger room.

In addition, under the condition that the calculated passenger room heating load is smaller than the second reference heating load and equal to or larger than a third reference heating load smaller than the second reference heating load as shown in Table 1 above, the control part 40 turns off the indoor heat exchanger 5a and the PTC heater 5b of the first heating heat exchangers 5 and turns on only the planar heating elements 22 of the second heating heat exchangers 20. At this time, the control part 40 turns on the blower 50.

Thus, under the condition that the calculated passenger room heating load is smaller than the second reference heating load and equal to or larger than the third reference heating load, only the planar heating elements 22 of the second heating heat exchangers 20 are operated, and the heat generated from the planar heating elements 22 is transferred to the passenger room through the air blown by the blower 50, thereby heating the passenger room.

As a result, it is possible to suppress the operations of both the PTC heater 5b and the heat pump, which consume a lot of power, whereby the passenger room can be heated while minimizing energy consumption in the heating mode.

In addition, under the condition that the calculated passenger room heating load is smaller than the third reference heating load as shown in Table 1 above, the control part 40 turns off the indoor heat exchanger 5a and the PTC heater 5b of the first heating heat exchangers 5 and turns on only the planar heating elements 22 of the second heating heat exchangers 20. At this time, the control part 40 turns off the blower 50.

Thus, under the condition that the calculated passenger room heating load is smaller than the third reference heating load, only the planar heating elements 22 of the second heating heat exchangers 20 are operated, and the heat generated from the planar heating elements 22 can heat the passenger room through radiant heating.

As a result, it is possible to suppress the operations of both the PTC heater 5b and the heat pump, which consume a lot of power, whereby the passenger room can be heated while minimizing energy consumption in the heating mode.

With this control part 40, by controlling the on/off operations of the first and second heating heat exchanger 5 and 20 according to the passenger room heating load, it is possible to effectively heat the passenger room while minimizing energy consumption in the heating mode.

In particular, the second heating heat exchangers 20, which consumes the least energy, are always turned on in the heating mode, and the indoor heat exchanger 5a and the PTC heater 5b of the first heating heat exchangers 5, which consume relatively high energy, are variably turned on and off depending on the passenger room heating load.

Therefore, it is possible to effectively heat the passenger room while minimizing energy consumption in the heating mode. As a result, the fuel efficiency of the vehicle can be improved without deteriorating the comfort in the passenger room.

Meanwhile, in the mode in which the blower 50 is not operated and only the planar heating elements 22 of the second heating heat exchangers 20 are turned on to radiantly heat the passenger room as shown in FIG. 2, the control part 40 controls the second heating heat exchangers 20 using the detection values of the second heating heat exchanger temperature sensors 30 that detects the temperatures of the second heating heat exchangers 20.

In the heating mode in which the blower 50 is operated, the control part 40 controls the first and second heating heat exchangers 5 and 20 using the detection values of the discharged air temperature sensors 42 installed on the air discharge port side of the respective vents 7, 8, 9 and 10.

Next, an operation example of the vehicular air conditioning system according to the present invention having such a configuration will be described with reference to FIGS. 2, 4 and 5. Hereinafter, a case where the first heating heat exchangers 5 include the indoor heat exchanger 5a and the PTC heater 5b will be described as an example.

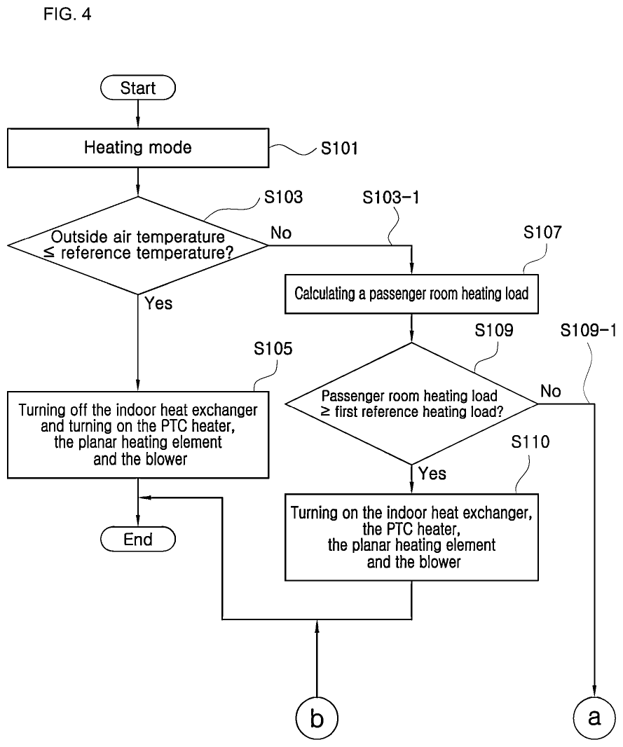

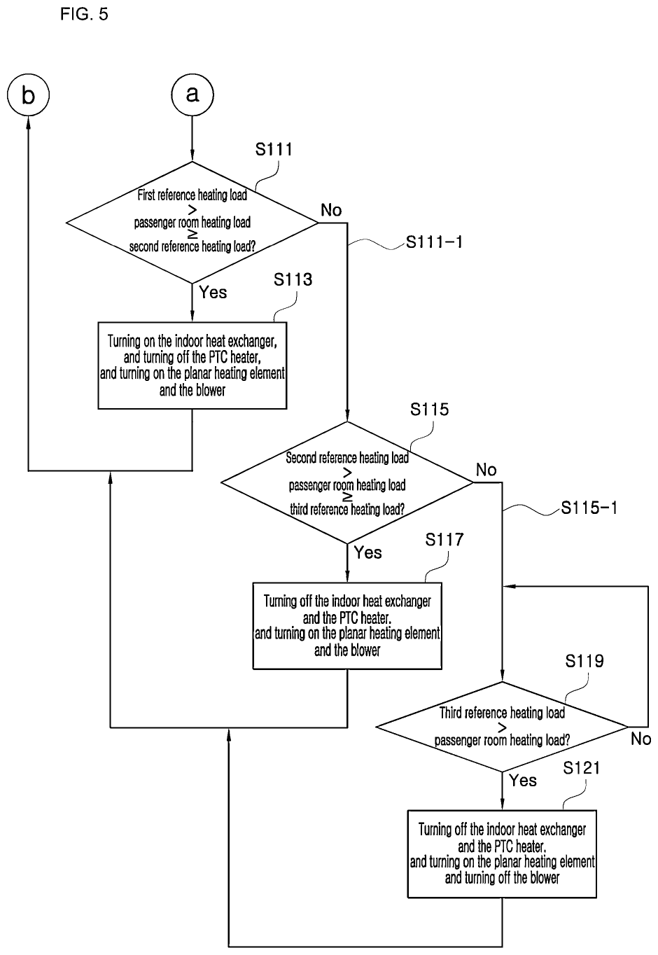

Referring first to FIGS. 4 and 5, when the air conditioning system is in the heating mode (S101), the control part 40 determines whether the outside air temperature is equal to or lower than a preset reference temperature (S103). For example, the control part 40 determines whether the outside air temperature is −20 degrees C. or lower.

If the result of determination indicates that the outside air temperature is −20 degrees C. or lower, the control part 40 recognizes that the indoor heat exchanger 5a of the heat pump is currently inoperable. Based on this recognition, the control part 40 turns off the indoor heat exchanger 5a of the first heating heat exchangers 5 (turns off the compressor of the heat pump type air conditioning system), turns on the PTC heater 5b, turns on the planar heating elements 22 of the second heating heat exchangers 20, and turns on the blower 50 (S105).

Then, the PTC heater 5b of the first heating heat exchangers 5 and the planar heating elements 22 of the second heating heat exchangers 20 are operated to heat the passenger room.

Meanwhile, if the result of determination indicates that the outside air temperature is not −20 degrees C. or lower (S103-1), the control part 40 calculates a passenger room heating load using at least one factor among the temperature of the air discharged into the passenger room, the outside air temperature, the inside air temperature, the user-set temperature, and the target discharge temperature (S107).

When the calculation of the passenger room heating load is completed, the control part 40 determines whether the calculated passenger room heating load is equal to or larger than a prestored first reference heating load (S109).

If the result of determination indicates that the calculated passenger room heating load is equal to or larger than the first reference heating load, the control part 40 turns on the indoor heat exchanger 5a and the PTC heater 5b of the first heating heat exchangers 5, turns on the planar heating elements 22 of the second heating heat exchangers 20, and turns on the blower 50 (S110).

Then, the indoor heat exchanger 5a and the PTC heater 5b of the first heating heat exchangers 5 and the planar heating elements 22 of the second heating heat exchangers 20) are all operated to heat the passenger room.

Meanwhile, if the result of determination in step S109 indicates that the passenger room heating load is not equal to or larger than the first reference heating load (S109-1), the control part 40 determines again whether the passenger room heating load is smaller than the first reference heating load and is equal to or larger than a second reference heating load smaller than the first reference heating load (S111).

If the result of determination indicates that the passenger room heating load is smaller than the first reference heating load and is equal to or larger than a second reference heating load, the control part 40 turns on the indoor heat exchanger 5a of the first heating heat exchangers 5, turns off the PTC heater 5b, turns on the planar heating elements 22 of the second heating heat exchangers 20, and turns on the blower 50 (S113).

Then, only the indoor heat exchanger 5a of the first heating heat exchangers 5 and the planar heating elements 22 of the second heating heat exchangers 20 are operated to heat the passenger room.

Meanwhile, if the result of determination in step S111 indicates that the passenger room heating load is smaller than the first reference heating load and is not equal to or larger than the second reference heating load (S111-1), the control part 40 determines again whether the passenger room heating load is smaller than the second reference heating load and equal to or larger than a third reference heating load smaller than the second reference heating load (S115).

If the result of determination indicates that the passenger room heating load is smaller than the second reference heating load and equal to or larger than the third reference heating load, the control part 40 turns off both the indoor heat exchanger 5a and the PTC heater 5b of the first heating heat exchangers 5, and turns on the planar heating elements 22 of the second heating heat exchangers 20 and the blower 50.

Then, only the planar heating elements 22 of the second heating heat exchangers 20 is operated so that the heat generated by the planar heating elements 22 is transferred to the passenger room through the air blown by the blower 50, thereby heating the passenger room.

Meanwhile, if the result of determination in step S115 indicates that the passenger room heating load is smaller than the second reference heating load and is not equal to or larger than the third reference heating load (S115-1), the control part 40 determines again whether the passenger room heating load is smaller than the third reference heating load (S119).

If the result of determination indicates that the passenger room heating load is smaller than the third reference heating load, the control part 40 turns off the indoor heat exchanger 5a and the PTC heater 5 of the first heating heat exchangers 5 and the blower 50, and turns on only the planar heating elements 22 of the second heating heat exchangers 20 (S121).

Then, only the planar heating elements 22 of the second heating heat exchangers 20 are operated so that the heat generated from the planar heating elements 22 can radiatively heat the passenger room.

According to the vehicular air conditioning system of the present invention having such a configuration, the second heating heat exchangers 20, which are the planar heating elements 22, are installed at the ends of the air discharge paths of the floor vent 9 and the rear floor vent 10 to directly heat the air discharged to the floor in the front and rear seat areas of the passenger room.

Therefore, in the heating mode, it is possible to efficiently heat the air on the floor vent 9 and rear floor vent 10 sides that are fed along the long air discharge paths.

In addition, since the air on the floor vent 9 and rear floor vent 10 sides can be heated efficiently, it is possible to quickly and effectively heat the floor side spaces in the front and rear seat areas of the passenger room that are relatively distant from the air conditioning case 1.

As a result, the comfort in the passenger room can be improved by improving the rapid cooling efficiency for the floor side spaces in the front and rear seat areas of the passenger room at the beginning of heating.

In addition, since the air discharged to the floor side spaces in the front and rear seat areas of the passenger room is heated by the low-power high-efficiency planar heating elements 22, it is possible to heat the air fed to the floor side spaces in the front and rear seat areas of the passenger room along the air discharge path to a high temperature while consuming less energy.

In addition, since the air fed to the floor side spaces in the front and rear seat areas of the passenger room along the air discharge path can be heated to a high temperature while consuming less energy, unlike the prior art, it is not necessary to increase the heat generation amount in the PTC heater 5b to compensate for the heat loss of the air in the process of feeding the air to the floor side spaces in the front and rear seat areas of the passenger room.

As a result, it is possible to heat the front and rear seat areas of the passenger room more efficiently while minimizing energy consumption, thereby improving both the comfort in the passenger room and the fuel efficiency of the vehicle.

In addition, since the temperature of the air discharged to the lower space of the passenger room can be independently controlled by the second heating heat exchangers 20 on the floor vent 9 and rear floor vent 10 sides, it is possible to make different the temperature of the air discharged to the lower space of the passenger room and the temperature of the air discharged to the upper space of the passenger room.

In addition, since the temperature of the air discharged to the lower space of the passenger room and the temperature of the air discharged to the upper space of the passenger room can be made different, it is possible to make the air discharged to the lower space of the passenger room higher than the temperature of the air discharged to the upper space of the passenger room.

As a result, it is possible to maintain a cold-head and hot-leg state and improve the comfort in the passenger room.

While the preferred embodiments of the present invention have been described above, the present invention is not limited to the above-described embodiments. Various modifications and changes may be made without departing from the scope and spirit of the present invention defined in the claims.

For example, in the detailed description and the drawings, the first heating heat exchangers 5 are described as being composed of the heater core or the indoor heat exchanger 5a and the PTC heater 5b. However, the first heating heat exchangers 5 may be composed of any one of the heater core, the indoor heat exchanger and the PTC heater.

1. A vehicular air conditioning system having an air inlet and an air outlet, comprising:
a first heating heat exchanger configured to heat an air introduced through the air inlet;
a second heating heat exchanger configured to heat air passing through the first heating heat exchanger or bypassing the first heating heat exchanger;
and a control part configured to control the first heating heat exchanger and the second heating heat exchanger according to a passenger room heating load so that when the heating load decreases to below a preset value in a heating mode in which the first heating heat exchanger and the second heating heat exchanger are operated simultaneously, the first heating heat exchanger is first turned off and only the second heating heat exchanger is operated.

2. The system of claim 1, wherein the first heating heat exchanger includes a plurality of heating heat exchangers.

3. The system of claim 2, wherein the first heating heat exchanger includes at least one of a heater core using engine cooling water, an indoor heat exchanger using a refrigerant of a heat pump, and a PTC heater using electricity.

4. The system of claim 3, wherein the first heating heat exchanger includes the indoor heat exchanger and the PTC heater, and
the control part is configured to, when an outside air temperature is equal to or lower than a preset reference temperature, turn off the indoor heat exchanger of the first heating heat exchanger, turn on the PTC heater, turn on the second heating heat exchanger, and turn on a blower so that the PTC heater of the first heating heat exchanger and the second heating heat exchanger are operated to heat a passenger room.

5. The system of claim 4, wherein the control part is configured to, when the passenger room heating load is equal to or larger than a pre-stored first reference heating load, turn on the indoor heat exchanger and the PTC heater of the first heating heat exchanger, the second heating heat exchanger, and the blower, so that under the condition that the passenger room heating load is equal to or larger than the first reference heating load, the indoor heat exchanger and the PTC heater of the first heating heat exchanger and the second heating heat exchanger are all operated to heat the passenger room.

6. The system of claim 5, wherein the control part is configured to, when the passenger room heating load is smaller than the first reference heating load and equal to or larger than a second reference heating load smaller than the first reference heating load, turn on the indoor heat exchanger of the first heating heat exchanger, turn off the PTC heater, turn on the second heating heat exchanger, and turn on the blower, so that under the condition that the passenger room heating load is smaller than the first reference heating load and equal to or larger than the second reference heating load, the indoor heat exchanger of the first heating heat exchanger and the second heating heat exchanger are operated to heat the passenger room.

7. The system of claim 6, wherein the control part is configured to, when the passenger room heating load is smaller than the second reference heating load and equal to or larger than a third reference heating load smaller than the second reference heating load, turn off the indoor heat exchanger and the PTC heater of the first heating heat exchanger, turn on a planar heating element of the second heating heat exchanger, and turn on the blower, so that under the condition that the passenger room heating load is smaller than the second reference heating load and equal to or larger than the third reference heating load, only the second heating heat exchanger is operated to heat the passenger room with the heat thereof.

8. The system of claim 7, wherein the control part is configured to, when the passenger room heating load is smaller than the third reference heating load, turn off the indoor heat exchanger and the PTC heater of the first heating heat exchanger, turn off the blower, and turn on only the second heating heat exchanger, so that under the condition that the passenger room heating load is smaller than the third reference heating load, only the second heating heat exchanger is operated to radiatively heat the passenger room with the radiant heat thereof.

9. The system of claim 8, wherein the first reference heating load, the second reference heating load and the third reference heating load are set under an outside air temperature condition in which a heat pump type air conditioning system is operable.

10. The system of claim 4, wherein the control part stores a specific outside air temperature at which a heat pump type air conditioning system is inoperable as a reference temperature, and the control part is configured to, when the outside air temperature is equal to or lower than the reference temperature, turn off the indoor heat exchanger, turn on the PTC heater, turn on the second heating heat exchanger, and turn on the blower.

11. A vehicular air conditioning system having an air inlet and an air outlet, comprising:
a first heating heat exchanger configured to heat air introduced through the air inlet;
a second heating heat exchanger configured to heat air passing through the first heating heat exchanger or bypassing the first heating heat exchanger;
and a control part configured to control the first heating heat exchanger and the second heating heat exchanger according to a passenger room heating load so that the second heating heat exchanger is turned on in a heating mode.

12. The system of claim 11, wherein the second heating heat exchanger is installed at an air discharge port of a vent that discharges air toward a floor of a passenger room among a plurality of vents for discharging air into the passenger room.

13. The system of claim 12, wherein the second heating heat exchanger includes a second heating heat exchanger installed at an air discharge port of a front seat side floor vent that discharges air to a floor in a front seat area of the passenger room, and a second heating heat exchanger installed at an air discharge port of a rear seat side floor vent that discharges air to a floor in a rear seat area of the passenger room.

14. The system of claim 11, further comprising:
discharged air temperature sensors installed at air discharge ports in the passenger room; and
a second heating heat exchanger temperature sensor configured to detect a temperature of the second heating heat exchanger.

15. The system of claim 14, wherein the control part is configured to, in a heating mode in which a blower is operated, control the first heating heat exchanger and the second heating heat exchanger using detection values of the discharged air temperature sensors installed at the air discharge ports, and is configured to, in a heating mode in which the blower is not operated and only a planar heating element of the second heating heat exchanger is operated, control the second heating heat exchanger using a detection value of the second heating heat exchanger temperature sensor.

16. The system of claim 11, wherein the second heating heat exchanger is a porous planar heating element configured to perform radiant heating.

17. The system of claim 11, wherein the control part is configured to calculate the passenger room heating load by processing at least one of a temperature of air discharged into a passenger room, an outside air temperature, an inside air temperature, a user-set temperature, and a target discharge temperature using a preset logic.
